(19) United States
(12) Patent Application Publication
(10) Pub. No.: US 2022/0179679 A1
(43) Pub. Date: Jun. 9, 2022

(54) COMPILATION OF EXPRESSIONS TO EMPLOY SOFTWARE TRANSACTIONAL MEMORY CONCURRENCY CONTROL OF AN IN-MEMORY DATABASE

(71) Applicant: Cisco Technology, Inc., San Jose, CA (US)

(72) Inventors: Pedro Ramalhete, St Sulpice (CH); Patrick Marlier, Lausanne (CH); Pratap Pereira, Saratoga, CA (US); Avaneesh Anandrao Kadam, San Jose, CA (US); Jeffrey yi dar Lo, Cupertino, CA (US); Tzewei Sou, Fremont, CA (US); Zhijian Zhang, Ottawa (CA)

(73) Assignee: Cisco Technology, Inc.

(21) Appl. No.: 17/247,299

(22) Filed: Dec. 7, 2020

(51) Int. Cl. G06F 9/46; G06F 8/41; G06F 16/22

(52) U.S. Cl. CPC G06F 9/467; G06F 16/22; G06F 8/41

(57) ABSTRACT

Disclosed herein are techniques to facilitate the performance database transactions directly by applications employing concurrency control of an in-memory database (IMDB) and the compilation of expressions to accomplish such database transactions. This disclosure describes techniques to facilitate the compilation of programming-language expressions into processor-executable instructions that employ software transactional memory (STM) concurrency control of an IMDB.

### TECHNICAL FIELD

The present disclosure generally relates to database transactions performed directly by applications employing concurrency control of an in-memory database and the compilation of expressions to accomplish such database transactions.

### BACKGROUND

A database is an organized collection of structured information, or data, typically stored electronically on secondary storage (e.g., disk storage) of a computer system. A database is usually controlled by a database management system (DBMS). Together, the data and the DBMS, along with applications associated with them, are referred to as a database system, often shortened to just database.

Typically, the DBMS itself manages all database transactions. Thus, database transactions (e.g., changes to the database) are managed by the DBMS to ensure compliance with the proper management of the data in the database.

Typically, when an executable program (i.e., application) attempts to read/write from/to a data record in a database, the application calls an application programming interface (“API”) for that very purpose. More particularly, a programmer may program an application to expressly call the appropriate API to read/write from/to that database. In this way, the application does not read or write directly to the database. Rather, the API acts as an intermediary. And the API ensures compliance with the proper management of the data in the database.

An in-memory database (“IMDB”) is a DBMS that primarily resides on a primary or main memory (e.g., working memory) of a computer system for its data storage. This is contrasted with a DBMS that employs a secondary storage mechanism (e.g., disk storage). Typically, IMDBs are faster than databases that use secondary storage mechanisms.

Applications where response time is critical, such as those running telecommunications network equipment and mobile advertising networks, often use IMDBs. Thus, IMDBs have gained much traction, especially in the data analytics space, starting in the mid-2000s—mainly due to multi-core processors that can address large memory and less expensive random-access memory (“RAM”), from which the main memory is constructed.

### BRIEF DESCRIPTION OF THE DRAWINGS

FIG. 1 illustrates an example computing system that implements the facilitation of to perform database transactions directly by applications employing concurrency control of an in-memory database and the compilation of expressions to accomplish such database transactions, in accordance with the techniques described herein.

FIG. 2 illustrates another example computing system that implements the facilitation of to perform database transactions directly by applications employing concurrency control of an in-memory database and the compilation of expressions to accomplish such database transactions, in accordance with the techniques described herein.

FIG. 3 illustrates an example of a logical transformation of source code to processor-executable instructions as performed by a compiler that is implemented in accordance with the techniques described herein.

FIGS. 4-6 illustrate flow diagrams of example methods for the facilitation of to perform database transactions directly by applications employing concurrency control of an in-memory database and the compilation of expressions to accomplish such database transactions, in accordance with the techniques described herein.

This detailed description of the drawings provides references to the accompanying figures. In the figures, the left-most digit(s) of a reference number identifies the figure in which the reference number first appears. The use of the same reference numbers in different figures indicates similar or identical items. The systems depicted in the accompanying figures are not to scale, and components within the figures may be depicted not to scale with each other.

### DESCRIPTION OF EXAMPLE EMBODIMENTS

### Overview

This disclosure describes techniques to perform database transactions directly by applications employing concurrency control of an in-memory database and the compilation of expressions to accomplish such database transactions. More particularly, this disclosure describes techniques to facilitate the compilation of programming-language expressions into processor-executable instructions that employ software transactional memory (STM) concurrency control of an in-memory database (IMDB). The method to perform the techniques described herein includes compiling source code in a high-level programming language into a processor-executable program and storing the processor-executable program in memory of a computer system for later execution.

The compiling may include obtaining an expression in the source code. The expression contains an operand of an IMDB transaction datatype (“transaction-typed operand”). The compiling may further include a determination that the expression contains the transaction-typed operand. In response to the determination, processor-executable instructions may be generated that employ STM concurrency control of an IMDB on a computer system's memory.

When executed by one or more processors of a computer system, the processor-executable instructions may cause the one or more processors to attain a value from the transaction-typed operand, retrieve data from a record in the IMDB on the memory of the computer system, the value indicating a location of the record in the IMDB, and evaluate the expression using the data retrieved from the record in the IMDB.

In addition, the method to perform the techniques described herein includes performing a database transaction on an IMDB on a primary memory of a computer system. During the transaction, the method includes obtaining a first address location of the first database record of the IMDB and storing the first address location of the first database record as a parent of a database object. Further, the method includes obtaining a second address location from the first database record, the second address location being the location of a second database record of the IMDB, and storing the second address location of the second database record as a child of the database object. Further still, the method includes the externalizing state of the IMDB based on the database object's parent and child.

Additionally, the techniques described herein may be performed by a system and/or device having non-transitory computer-readable media storing computer-executable instructions that perform the method described above when executed by one or more processors.

### EXAMPLE EMBODIMENTS

This disclosure describes techniques to facilitate the compilation of programming-language expressions into processor-executable instructions that employ STM concurrency control of an IMDB. In addition, this disclosure describes techniques to facilitate a determination of which database records were updated and effectively report that for database purposes.

Generally, a database is usually controlled and managed by a database management system (DBMS). Some databases are scalable. Database scalability is the ability of a database to handle changing demands by adding/removing resources. A DBMS is scalable if it can increase its workload and throughput when additional resources are added. A scalable DBMS can react to evolving needs with adjustable resources to serve a changing workload without requiring downtime.

Scalability can mean managing a growing volume of data, e.g., as the database size grows from 100 GB to 1 TB to 100 TB, etc. In the context of database systems, this is vertical scalability.

Scalability can also mean the ability to handle more and more concurrent accesses and maintain performance. Or to increase aggregate performance by adding more and more concurrent connections. For example, if one thread can do X amount of work, ten threads could ideally do 10× the amount of work. This is horizontal scalability. Herein, the database scalability referenced herein is horizontal scalability.

An in-memory database (“IMDB”) is a DBMS that primarily resides on a computer system's primary memory for its data storage. This is contrasted with a typical DBMS that employs a secondary storage mechanism (e.g., disk storage). The memory of a computer system may be classified into two categories: primary and secondary memory. Primary memory is the main or working memory of the computer system where the currently processing data resides—the data stored in primary memory for quick access. The computer system's secondary memory is auxiliary or persistent memory, where the data is stored effectively permanently. The data stored in secondary memory is stored for long-term data retention and slower access.

IMDBs are faster than traditional DBMSs, primarily because access to primary memory is faster than secondary memory access. IMDBs are ideal for applications that require microsecond response times and can have large spikes in traffic coming at any time, such as gaming leaderboards, session stores, and real-time analytics. IMDBs are faster because they eliminate the need to access secondary storage. In some instances, IMDBs may be called main-memory databases (MMDB).

A database transaction symbolizes a unit of work performed within or by a DBMS against a database. A database transaction affects a change to the database. For example, a database transaction may read data from a record in a database or write data to a database record. A record in a database may be a complete set of information about something. That is, a database record stores one or more presumably associated values.

A DBMS treats each database transaction (herein simply, “transaction”) coherently and reliably that is independent of other transactions. A transaction generally represents any change in a database. Customarily, reliable database transactions are ACID compliant. ACID is an acronym for Atomic, Consistent, Isolated, and Durable.

An atomic transaction is either complete in its entirety or does not affect whatsoever. A consistent transaction must conform to existing constraints in the database. An isolated transaction must not affect other transactions. A durable transaction must be stored in persistent storage. Typically, the DBMS manages all database transactions. Thus, transactions are managed by the DBMS to ensure ACID compliance.

Thus, when an executable program (i.e., application) attempts to read/write from/to a data record in a database, the application does not do so directly. Rather, the application requests a transaction of the database from the DBMS. This is typically accomplished by the application calling an application programming interface (“API”) for that very purpose. More particularly, a programmer may program an application to expressly call a DBMS-appropriate API to read/write from/to the database managed by the DBMS. In this way, the application does not read or write directly to the database. Rather, the API acts as an intermediary. And the API and the DBMS ensure ACID compliance with the database.

Typically, IMDB is employed when speedy responsiveness is desirable. Thus, it is further desirable to bypass the API's intermediary function to avoid the complication of and the delay of the intermediary action. Instead, the applications could call and directly interact with the IMDB. However, having the applications directly interact with the IMDB introduces potentially new issues.

For example, without the API enforcing ACID compliance, how does the application ensure ACID compliance? This is a particular concern in light of the possibility that the application may have multiple different concurrent processes accessing the same record in the IMDB. With concurrent processing, multiple processors execute instructions simultaneously for better performance. Unfortunately, concurrent processes of an application could attempt to read or write the same record simultaneously. Without proper management of this potential occurrence, ACID-compliance cannot be ensured.

Another example of a potential issue involves how an application can know which records were updated to effectively report that for database purposes, such as for database replication. Database replication involves storing data of a database in more than one location or node. With multiple “mirrored” databases, users may access data relevant to their tasks from the most convenient duplicate of the database without interfering with others' work.

Generally, the techniques described herein offer mechanisms to address and solve these concerns. According to the techniques described herein, a compiler that generates an application that makes ACID-compliant calls to an IMDB that handle the possibility that the application may have multiple different concurrent processes concurrently accessing the same record in the IMDB and enable the application to be able to determine which records were updated and effectively report that for database purposes.

Certain implementations and embodiments of the disclosure will now be described more fully below regarding the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

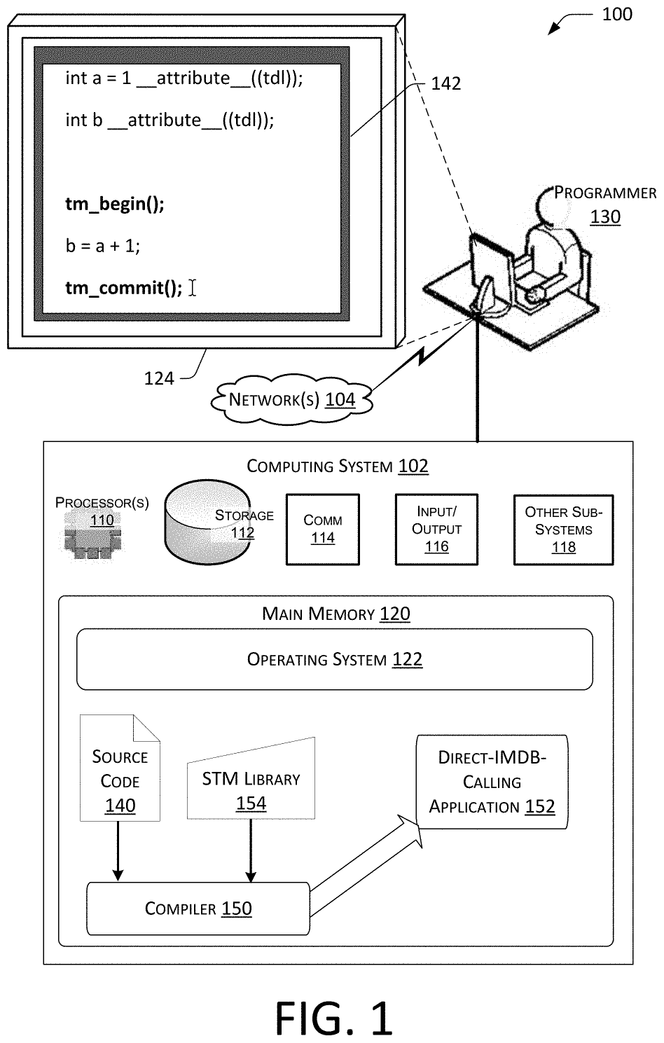

FIG. 1 illustrates an example scenario 100 that implements the facilitation of the technology described herein. The example scenario 100 includes a computing system 102, one or more communications networks 104, and a programmer 130.

The computing system 102 is a programmable electronic device that has multiple subsystems that are designed to accept, process, and store data, perform prescribed mathematical and logical operations at high speed, and present, store, or transmit the results of these. Examples of a suitable computing system 102 include (but is not limited to): a computer, a mobile device, a server, a tablet computer, a notebook computer, handheld computer, a workstation, a desktop computer, a laptop, a tablet, user equipment (UE), a network appliance, an e-reader, a wearable computer, a network node, a microcontroller, a smartphone, or another computing device that configured like how the computing system 102 is described herein and is capable of performing the functionalities presented herein.

The one or more communications networks 104 is a collection of interconnected computing devices (i.e., network nodes) that use common communication protocols over digital interconnections to share resources or services located on or provided by the network nodes. The interconnections between nodes are formed from one or more of a broad spectrum of telecommunication network technologies, based on physically wired, optical, and wireless radio-frequency methods that may be arranged in a variety of network topologies. The so-called cloud and so-called Internet are examples of a suitable communications network.

It should be appreciated that the configuration and network topology described herein has been dramatically simplified and that many more computing systems, software components, networks, servers, services, and networking devices can be utilized to interconnect the various computing systems disclosed herein and to provide the functionality described herein.

As depicted in FIG. 1, the computing system 102 includes multiple subsystems, such as one or more central processing units (“CPUs”), which are called “processor(s)” 110 herein, a storage subsystem 112, a communications subsystem 114, an input/output subsystem 116, other subsystems 118, a main memory 120, and an operating system (OS) 122.

The processor(s) 110 operates in conjunction with a chipset (not shown). The processor(s) 110 can be standard programmable processors that perform arithmetic and logical operations necessary for the operation of the computing system 102.

The computing system 102 includes a “motherboard,” a printed circuit board to which a multitude of the subsystems can be connected by way of a system bus or other electrical communication paths. The processor(s) 110 can be standard programmable processors that perform arithmetic and logical operations necessary for the operation of the computing system 102.

The processor(s) 110 perform operations by transitioning from one discrete, physical state to the next by manipulating switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

As described herein, the computing system 102 may include one or more hardware processor(s) 110 configured to execute one or more stored instructions. The processor(s) 110 may comprise one or more cores. The chipset (not shown) may provide an interface between the processor(s) 110 and the remainder of the subsystems on the motherboard.

Further, the computing system 102 may include the communications subsystem 114, such as a gigabit Ethernet adapter, that is configured to provide communications between the computing system 102 and other devices through a network, such as one or more communications networks 104. The communications subsystem 114 may include network interfaces configured to couple the computing system 102 to personal area networks (PANs), wired and wireless local area networks (LANs), wired, and wireless wide area networks (WANs), and so forth. For example, the network interfaces may include devices compatible with Ethernet, Wi-Fi™, and so forth.

The computing system 102 can be connected to the storage subsystem 112 that provides non-volatile storage for the computing system 102. As the secondary memory of the computer system 102, the storage subsystem 112 is auxiliary or persistent memory where data is stored effectively permanently. The data stored in secondary memory is stored for long-term data retention and slower access.

The storage subsystem 112 can consist of one or more physical storage units. The storage subsystem 112 can interface with the physical storage units through a serial attached SCSI (“SAS”) interface, a serial advanced technology attachment (“SATA”) interface, a fiber channel (“FC”) interface, or other types of interface for physically connecting and transferring data between computers and physical storage units. Unless the context indicates otherwise, a data, herein, includes information processed or stored by a computer system. Such information may include text documents, images, audio clips, videos, and the like.

The computing system 102 can store data on the storage subsystem 112 by transforming the physical state of the physical storage units to reflect the stored information. The specific transformation of physical state can depend on various factors, in different embodiments of this description. Examples of such factors can include but are not limited to, the technology used to implement the physical storage units, whether the storage subsystem 112 is characterized as primary or storage, and the like.

For example, the computing system 102 can store information to the storage subsystem 112 by issuing instructions to the storage subsystem 112 to alter the magnetic characteristics of a particular location within a magnetic disk drive unit, the reflective or refractive characteristics of a particular location in an optical storage unit, or the electrical characteristics of a particular capacitor, transistor, or other discrete parts in a solid-state storage unit. Other transformations of physical media are possible without departing from the present description's scope, and spirit, with the foregoing examples, provided only to facilitate this description. The computing system 102 can further read information from the storage subsystem 112 by detecting the physical states or characteristics of one or more particular locations within the physical storage units.

In addition to the storage subsystem 112 described above, the computing system 102 can access other computer-readable storage media to store and retrieve information, such as applications, program modules, data structures, or other data. It should be appreciated by those skilled in the art that computer-readable storage media is any available media that provides for the non-transitory storage of data, and that can be accessed by the computing system 102.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The storage subsystem 112 can store the OS 122 utilized to control the operation of the computing system 102. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage subsystem 112 can store applications, program modules, and data utilized by the computing system 102.

In one embodiment, the storage subsystem 112 or other computer-readable storage media is encoded with components (e.g., processor-executable instructions), which, when loaded into the computing system 102, transform the computing system 102 from a general-purpose computing system into a special-purpose computer capable of implementing the embodiments described herein. These components transform the computing system 102 by specifying how the processor(s) 110 transition between states, as described above.

The computing system 102 can also include the input/output subsystem 116 for receiving and processing input from several input devices, such as a keyboard, a mouse, a touchpad, a touch screen, an electronic stylus, or other types of input devices. Similarly, the input/output subsystem 116 can provide output to a display 124, such as a computer monitor, a flat-panel display, a digital projector, a printer, or other types of output devices.

The computing system 102 can also include other subsystems 118, such as a graphics processing unit (GPU) subsystem, a baseboard management controller (BMC), and/or an audio subsystem. The GPU subsystem is a specialized electronic circuit designed to rapidly manipulate and alter memory to accelerate the creation of images in a frame buffer intended for output to a display. The BMC is a small independent computing system inside a server. The BMC is a specialized built-in but an independent computing system that monitors the physical state of the server hardware and/or the server's operating system's functionality.

The main memory 120 is a computer-readable storage medium for storing data and applications thereon. The main memory 120 is the primary memory or working memory of the computer system 102, where the currently processing data resides—the data stored in primary memory for quick access.

The main memory 120 may include read-only memory (“ROM”) and/or non-volatile RAM (“NVRAM”) for storing the data and applications. The ROM or NVRAM can also store other applications and software components that facilitate the operation of the computing system 102 in accordance with the configurations described herein.

Unless the context indicates otherwise, an application, herein, includes a set of processor-executable instructions that may be executed by processors of a computer system, such as processor(s) 110 of the computer system 102. An application may be described as a program product. An application is comprised of software components (or simply, “components”). A component being, for example, a set of executable instructions.

As depicted, the main memory 120 stores a compiler 150 and a direct-IMDB-calling application 152, which are examples of applications. The main memory 120 stores source code 140, which is an example of data stored in the main memory 120. Of course, in other instances, the source code may be stored in the storage subsystem 112.

Unless the context indicates otherwise, a compiler, herein, includes a special-purpose application designed to operate on a computer system that creates an application from a source code written in a programming language. That is, a compiler translates source code written in a high-level programming language (i.e., the “source” language) into an executable program of processor-executable instructions in a low-level language (i.e., the “target” language). Examples of such low-level or target languages include assembly language, object code, or machine code.

Unless the context indicates otherwise, source code, herein, includes a human-readable text written in a specific programming language. The source code, such as source code 140, of a program is specially designed to facilitate computer programmers' work, like the programmer 130. A compiler often transforms the source code into binary machine code that can be executed by the computer.

Unless the context indicates otherwise, a programming language, herein, includes is a vocabulary and set of grammatical rules for instructing a computer or processor to perform specific tasks. Alone, the term programming language usually refers to high-level languages, such as BASIC, C, C++, COBOL, Java, FORTRAN, Ada, and Pascal.

While simple compared to human languages, high-level programming languages are written in a human-readable text and thus are more complex than the languages the computer actually understands, which are called machine languages or code. Each different type of processor has its unique machine code.

Lying between machine languages and high-level languages are languages such as assembly language and object code. Assembly languages are similar to machine code, but they are much easier to program because they allow a programmer to substitute names for numbers. Typically, the machine code consists of numbers only.

In a general sense, object code includes a sequence of statements or instructions organized into files linked together to form an application. Object code is usually in machine code (i.e., binary) or an intermediate language such as register transfer language (RTL).

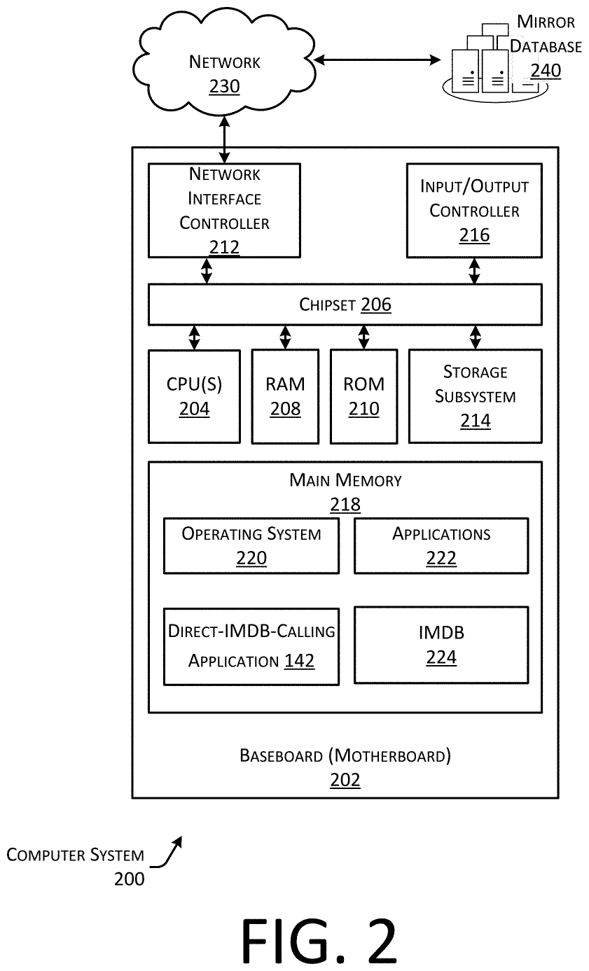

FIG. 2 shows an example computer architecture for a computing system 200 capable of executing the direct-IMDB-calling application 152 and any other program components for implementing the functionality described above. The computing system 200 is similar in most ways to the computing system 102 described above. Indeed, in some instances, the computing system 200 and computing system 102 may be the same computing system.

The computer architecture shown in FIG. 2 illustrates a conventional server computer, workstation, desktop computer, laptop, tablet, network appliance, e-reader, smartphone, or another computing device. It can be utilized to execute any of the functionalities presented herein.

The computing system 200 includes a baseboard 202, or “motherboard,” which is a printed circuit board to which many components or devices can be connected by way of a system bus or other electrical communication paths. In one illustrative configuration, one or more central processing units (“CPUs”) 204 operate in conjunction with a chipset 206. The CPUs 204 can be standard programmable processors that perform arithmetic and logical operations necessary for the operation of the computing system 200. The CPUs 204 is much like the one or more processors 110 described above.

The chipset 206 provides an interface between the CPUs 204 and the remainder of the components and devices on the baseboard 202. The chipset 206 can provide an interface to a RAM 208, used as the main memory in the computing system 200. The chipset 206 can further provide an interface to a computer-readable storage medium such as ROM 210 or NVRAM for storing basic routines that help to startup the computing system 200 and to transfer information between the various components and devices. The ROM 210 or NVRAM can also store other software components necessary for the operation of the computing system 200 in accordance with the configurations described herein.

The computing system 200 can operate in a networked environment using logical connections to remote computing devices and computer systems through a network, such as the network 230. The chipset 206 can include functionality for providing network connectivity through a NIC 212, such as a gigabit Ethernet adapter. The NIC 212 can connect the computing system 200 to other computing devices over the network 230. It should be appreciated that multiple NICs 212 can be present in the computing system 200, connecting the computer to other types of networks and remote computer systems.

The computing system 200 can be connected to a mirror database system 240 via the network 230. The mirror database system 240 is one or more computing systems that host a backup copy of the IMDB 224. This backup copy is called a mirror database. Having a mirror database helps ensure continuous data availability and avoid downtime. As depicted, the mirror database of the IMDB 224 is part of the mirror database system 240 is physically separate and potentially remote from the computing system 200. In other instances, the mirror database of the IMDB 224 is part of the computing system 200.

When complete accuracy of the mirror database is desired, the mirror database is updated frequently. For example, all changes to the IMDB 224 may be copied to the mirror database system 240 quickly after a change is made. In this mode, known as synchronous operation, the mirror is called a hot standby. In other instances, the database mirroring content is not fully and immediately synchronized. In those instances, some data loss may occur if one of the IMDB 224 instance fails or becomes inaccessible. In this mode, called asynchronous operation, the mirror is called a warm standby.

The computing system 200 can be connected to a storage subsystem 214 that provides non-volatile secondary storage for the computer. The storage subsystem 214 can store an operating system 220, applications 222, the direct-IMDB-calling application 152, data, and an IMDB 224. The storage subsystem 214 can be connected to the computing system 200 through a storage controller (not shown) connected to the chipset 206. The storage subsystem 214 can consist of one or more physical storage units. The storage subsystem 214 may be similar in many ways to the storage subsystem 112 described above.

The main memory 218 is a computer-readable storage medium for storing data, IMDBs, and applications thereon. The main memory 218 is the primary memory or working memory of the computer system 200, where the currently processing data resides—the data stored in the main memory 218 for quick access.

In one embodiment, the main memory 218 or other computer-readable storage media is encoded with computer-executable instructions which, when loaded into the computing system 200, transform the computer from a general-purpose computing system into a special-purpose computer capable of implementing the embodiments described herein. These computer-executable instructions transform the computing system 200 by specifying how the CPUs 204, like processors 110 described above, transition between states.

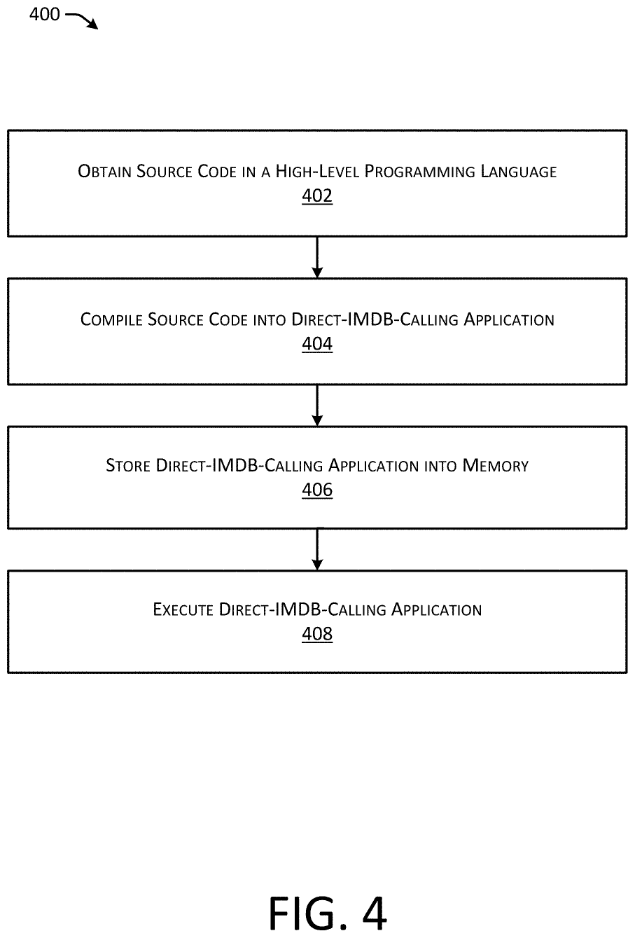

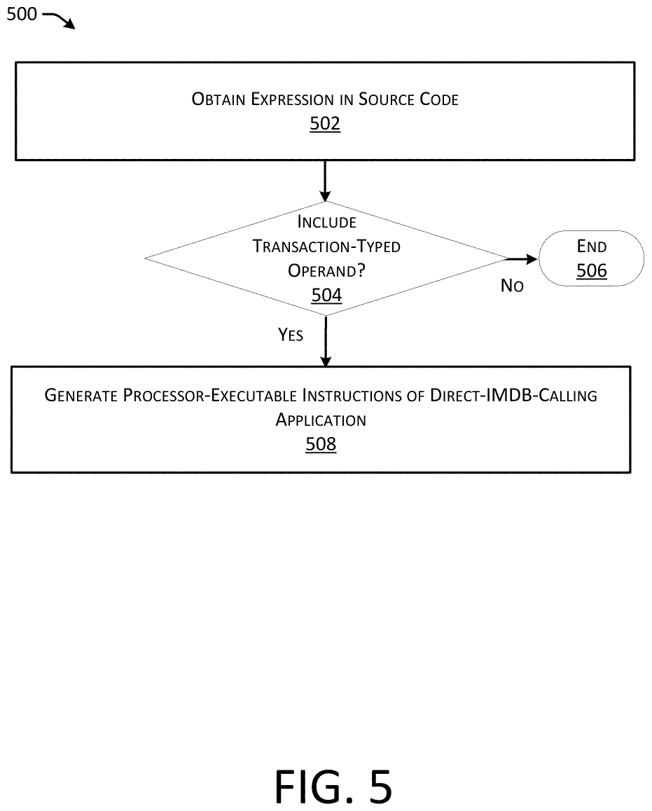

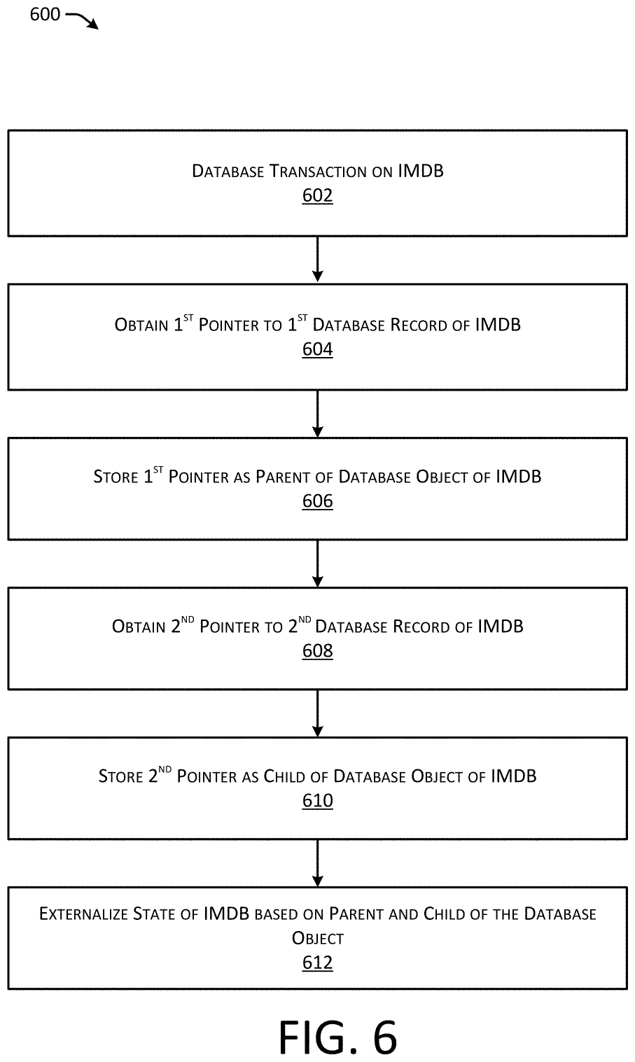

According to one embodiment, the computing system 200 has access to computer-readable storage media storing computer-executable instructions that, when executed by the computing system 200, perform the process described above regarding FIGS. 4, 5, and 6. The computing system 200 can also include computer-readable storage media with instructions stored thereupon to perform any of the other computer-implemented operations described herein. The operating system 220 utilized to control the operation of the computing system 200 may be similar to the OS 122 described above.

The computing system 200 can also include one or more input/output controllers 216 for receiving and processing input from several input devices. The input/output controllers 216 may be similar to the input/output subsystem 116, described above. It will be appreciated that the computing system 200 might not include all of the components shown in FIG. 2, can include other components that are not explicitly shown in FIG. 2, or might utilize an architecture completely different than that shown in FIG. 2.

The computing system 200 can also include at least one IMDB 224 that primarily resides in the main memory 218 of the computing system 200. More particularly, the IMDB 224 is a horizontally scalable in-memory database. The direct-IMDB-calling application 152 performs direct database transactions on the IMDB 224.

As indicated in FIG. 1, the programmer 130 is an individual or a group of individuals who write/create source code that, when translated into an application, direct a computer to perform specific instructions to acquire, process, calculate, move, transfer, translate etc. data.

FIG. 1 shows the snippet 142 of the source code 140 as it is displayed on the display 124. With the technology described herein, the programmer 130 creates the source code 140 (including the snippet 142) using a programming language to perform a database transaction with an IMDB. For this example, the programing-language of the snippet 142 is C.

Using conventional approaches, a programmer needed to hard code all necessary ACID compliance into their source code to perform a database transaction directly with an IMDB. Consequently, even the simplest database transaction required extensive coding to achieve ACID compliance.

However, the programmer 130 may generate source code 140 with typical programming-language expressions with the technology described herein. The programmer wishes to perform a database transaction directly with an IMDB of a computing system, such as the IMDB 224 of the computing system 200. With the technology described herein, rather than writing custom database transaction expressions in their code, the programmer 130 flags that their code will act on an IMDB. Consequently, the compiler 150 will use database-transaction specific operations to realize the programmer's code's runtime database transactions.

To flag that their code will act on an IMDB, the programmer 130 uses special datatypes for the operands of the expressions to indicate the desire for the compiler 150 to translate the expressions to perform one or more database transactions directly with the IMDB 224 operating on the computing system 200.

The compiler 150 produces the direct-IMDB-calling application 152 from the source code 140 generated by the programmer 130. The compiler 150 compiles the source code 140 in a high-level programming language into a processor-executable program (e.g., direct-IMDB-calling application 152) stores the processor-executable program in memory of a computer system (e.g., the main memory 120 of the computing system 102) for later execution.

The resulting direct-IMDB-calling application 152, when executed on the computing system 200 that hosts the IMDB 224, performs one or more database transactions directly on that IMDB. The resulting direct-IMDB-calling application 152 does so by employing STM concurrency control of that IMDB.

Concurrency control is part of concurrent computing, a form of computing in which several computations are executed concurrently—during overlapping periods—instead of sequentially, with one completing before the next starts. Creating applications for a concurrent computer is called concurrent programming. Transactional memory (TM) attempts to simplify concurrent programming by allowing a group of load and store instructions to execute in an atomic way. That is, they execute without interfering with each other.

TM is a concurrency control mechanism that provides high-level abstraction as an alternative to low-level thread synchronization. This abstraction allows for coordination between concurrent reads and writes of shared data in a parallel system.

In some instances of TM, the concurrent control is maintained by lock-based synchronization. Lock-based synchronization constructs are pessimistic and prohibit concurrent processes outside a critical section from making any changes. Applying and releasing locks often functions as additional overhead in workloads with little conflict among concurrent processes.

The main memory 218 of the computing system 200 is a shared memory in the concurrent computing context described herein. Likewise, the CPU(s) 204 of the computing system 200 performs concurrent processes that share the main memory 218. Also, the direct-IMDB-calling application 152 produced by the compiler 150 performs concurrency control of the IMDB 224, stored on the shared main memory 218.

Unless the context indicates otherwise, STM, herein, includes a concurrency control mechanism for controlling access to shared memory in concurrent computing. It is an alternative to lock-based synchronization. STM is a strategy implemented in software, rather than as a hardware component. A transaction in this context occurs when an application reads and writes to shared memory. These reads and writes logically occur at a single instant in time. The intermediate states are not visible to other successful transactions.

With the techniques described herein, the compiler 150 generates an application (e.g., the direct-IMDB-calling application 152) that interacts directly with the IMDB 224 using STM concurrency control to maintain ACID compliance of the IMDB. For example, the STM concurrency control functionality is built into the compiler, and the compiler 150 incorporates the STM concurrency control functionality into the resulting application based on special datatyping of an operand in an expression of the source code.

In some instances, the application resulting from the compiler 150 accesses the appropriate runtime STM operation from a library 154 of STM concurrency control operations. The STM concurrency control operations in this library 154 perform database transactions (e.g., read, write, add, and delete) using STM concurrency controls to maintain ACID compliance of the IMDB 224.

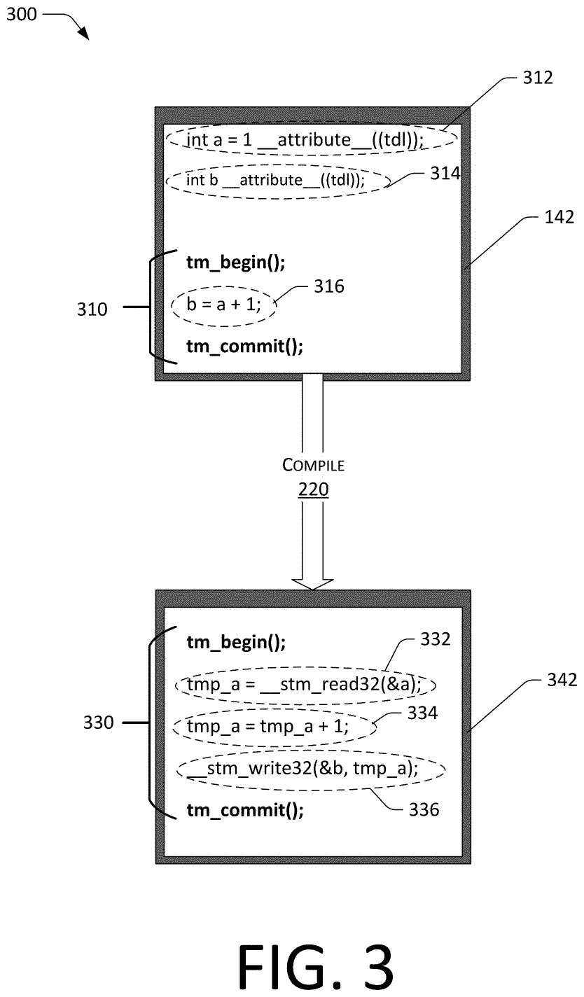

FIG. 3 illustrates an example of a logical transformation performed by the compiler 150 on a snippet 142 of the source code 140. More particularly, the compiler 150 translates or compiles (as indicated by arrow 320) the snippet 142 of the source code 140 into a set 342 of processor-executable instructions of the direct-IMDB-calling application 152.

As depicted in FIG. 3, the compiler 150 creates processor-executable instructions that may cause the one or more processors to attain a value from the transaction-typed operand, retrieve data from a record in the IMDB 224 stored in the main memory 218 of the computer system 200 (that value indicates a location of the record in the IMDB), and evaluate the expression using the data retrieved from the record in the IMDB.

As depicted, the snippet 142 includes a variable initialization and declaration 312 and a variable declaration 314. The variable initialization and declaration 312 loads an initial value of “1” into an integer variable “a.” The variable initialization and declaration 312 also assigns a datatype labeled “_attribute_((tdl))” to the variable “a.” The variable declaration 314 assigns the same datatype, “_attribute_((tdl)),” to the variable “b.”

This datatype label of “_attribute_((tdl))” is an example of a particular label that may be used to identify a variable as IMDB-transaction datatype. Thus, variables “a” and “b” have a datatype of IMDB-transaction. Other implementations may use different labels or names than “_attribute_((tdl))” to identify variables as its database-transaction datatype.

Unless the context indicates otherwise, a datatype, herein, includes an attribute of data that tells the compiler 150 how the programmer 130 intends to use the data. Most programming languages support basic datatypes of integer numbers, floating-point numbers, characters, and Booleans. Often, a datatype constrains the values that an expression, such as a variable or a function, might take. This datatype of the technology described herein defines the operations that can be done on the data, the meaning of the data, and the way values of that type can be stored.

For the compiler 150, the IMDB-transaction datatype is a special datatype that indicates that the variables “a” and “b” are associated with STM operations. Thus, any operations taken with these datatyped variables will be STM operations rather than typical operations that may be performed with a differently typed variable. The STM operations include runtime STM concurrency control actions performed directly on the IMDB 224 on the computing system 200 on which the direct-IMDB-calling application 152 is executing.

As depicted, the snippet 142 includes a program module 310 with “tm_begin( )” defining its beginning and “tm_commit( )” defining its ending. The program module 310 has a single line of programming. Indeed, that line is an expression 316 “b=a+1.” In the expression 316, the variable “a” is an operand and the plus symbol is an operator. Thus, the variable “a” is an operand of the IMDB-transaction datatype (i.e., “transaction-typed operand”).

Unless the context indicates otherwise, an expression, herein, includes a syntactic entity in a programming language that may be evaluated to determine its value. An expression may be a combination of one or more constants, variables, functions, and operators that the programming language interprets (according to its particular rules of precedence and association) and computes to produce another value. This process, for mathematical expressions, is called evaluation. In contrast, a statement (e.g., an instruction) is a syntactic entity with no value.

For example, 2+3 is both an arithmetic and programming expression, which evaluates to 5. A variable is an expression because it denotes a value in memory, so y+6 is also an expression. An example of a relational expression is 4 #4, which evaluates to false.

Unless the context indicates otherwise, an operand, herein, includes a part of a computer instruction that specifies what data is to be manipulated or operated on, while at the same time representing the data itself. That is, the operand describes the object that is capable of being manipulated. For example, in “1+2,” the “1” and “2” are the operands, and the plus symbol is the operator.

An arrow 320 indicates compilation performed by the compiler 150 in transforming the snippet 142 of the source code 140 into the set 342 of processor-executable instructions of the direct-IMDB-calling application 152. During the compiling, the compiler 150 obtains an expression, like the expression 316, in the source code 140. The expression 316 contains an operand of the transaction-typed operand. More particularly, the variable “a” is the operand of the transaction-typed operand in the expression 316.

As depicted in FIG. 3, the set 342 of processor-executable instructions is presented in a human-readable form for illustration purposes here. However, as its name implies, the set 342 of processor-executable instructions would be in the form of instructions executable by one or more processors of a computing system. The set 342 of processor-executable instructions may be described as being in a low-level or target language. Examples of such low-level or target languages include assembly language, object code, or machine code.

As depicted in FIG. 3, the set 342 of processor-executable instructions represents the functionality that results from the compilation of the snippet 142 of the source code 140 using STM operations that include runtime STM concurrency control actions performed directly on the IMDB 224 on the computing system 200 on which the direct-IMDB-calling application 152 is executing.

The set 342 of processor-executable instructions includes a program module 330 with “tm_begin( )” defining its beginning and “tm_commit( )” defining its ending. The program module 330 has three lines of instructions.

A first line of instructions 332 reads: “tmp_a=_stm_read32(&a);”. In response to the first line of instructions 332, the compiler 150 employs a database-transaction operation from the compiler's STM runtime library 154. Since the variable “a” from the snippet 142 is a transaction-typed operand and that operand was part of the expression 316, the compiler 150 uses the compiler's appropriate database-transaction operation's STM runtime library 154.

In particular, the compiler 150 uses a specific STM operation to read (“_stm_read32( )”) a record in the IMDB 224. The “&a” means that the “address of” the value of the variable “a” should be read from the IMDB 224. Since the value of a was initialized to “1,” the data in the record of the IMDB 224 is read and stored in a temporary or working storage location called “tmp_a.”

A second line of instructions 334 reads: “tmp_a=tmp_a+1;”. In response to the second line of instructions 334, the compiler 150 adds the value of “1” to the value in the temporary storage location called “tmp_a.” Thus, the value of 1 is added to whatever value was read in the record of the IMDB 224.

A third line of instructions 336 reads: “_stm_write32(&b, tmp_a);”. In response to the third line of instructions 336, the compiler employs a database-transaction operation from the compiler's STM runtime library 154. Since the variable “a” from the snippet 142 is a transaction-typed operand and that operand was part of the expression 316, the compiler 150 uses the compiler's appropriate database-transaction operation's STM runtime library 154.

In particular, the compiler 150 uses a specific STM operation to write (“_stm_write32( )”) the value in temporary storage location called “tmp_a” into a record in the IMDB 224 at location of b (as indicted by “&b”).

With the technology described herein, the programmer 130 may use the typical programming expressions with which they are familiar to perform database transactions with the IMDB 224. When the programmer 130 uses a special transaction-typed operand in their expressions, the compiler 150 manages the database transactions with the IMDB in an ACID-compliant manner.

Often, it is desirable to externalize the state of the IMDB 24. That is, the current state of the IMDB 224 may be copied or replicated in some way. For example, externalizing the state of the IMDB 224 includes copying or replicating the database to, for example, the mirror database system 240. This may be useful for restorability, restartablity, reliability, telemetry, and the like. The replication involves ongoing synchronization of updated database records and database objects of the IMDB 224. A log of updated records may be used for that purpose. The log typically includes the objects related to the changed records to be updated and located accordingly.

A database object in a relational database is a data structure used to either store or reference data. A common example is a table. A table is a collection of related data held in a table format within a database. It consists of columns and rows. Other objects include indexes, stored procedures, sequences, views, and many more.

Since the records of a database object are interrelated, the change in one record may affect the rest of the object. For example, an object may include several records related to a person: John Smith is a male 24-year-old who lives in 78745 zip code. If the executable program (e.g., the direct-IMDB-calling application 152) changes the zip code's value, it may be helpful to know that the records related to John Smith have been updated. In some instances, the helpfulness of know which records were updated may be necessary or vital to externalize the state of the object of the IMDB 224.

Using conventional approaches, a programmer would call a particular API before ending a database transaction. That API would track or log all database changes includes identifying the objects of the updated records. This API maintains an appropriate log of the updated records and objects that should be synchronized.

Using the technology described herein, how does a direct-IMDB-calling application 152 track the changes made to a database object's records during a particular transaction? No APIs are called. One way to accomplish this is to have the executable program track every database interaction during the runtime and then correlate those interactions to identify the exact objects transacted with. However, to do so may require the runtime executable program to track many interactions and intensive database object correlation.

With the technology described herein, the compiler 150 incorporates functionality into the direct-IMDB-calling application 152 to track object containment based on the changed records. This is accomplished without adding any new context (e.g., logging all database interactions) within the database object. It is desirable to avoid managing extra context to avoid memory bloat of the IMDB. This approach adds little overhead to the processors. And no special API is needed.

The technology described herein introduces object containment tracking (OCT) functionality. The executable program (e.g., the direct-IMDB-calling application 152) determines a parent-child relationship amongst the records of the IMDB 224 on which the executable program has performed a database transaction. The executable program created by the compiler 150 will locate the record that it wishes to access by climbing through the database object's parent-child relationship tree.

For example, consider Table 1 below.

TABLE 1
Personnel Object

| Name | John Smith |
|---|---|
| Gender | Male |
| Age | 24 |

As depicted, Table 1 is naturally arranged to show the relational nature of the data held in the database object called “Personnel Object.” However, in reality, when accessed by the executable program, the Personnel Object is a list of memory locations (i.e., “pointers”) to the table's values.

If, for example, the executable program's goal is to change the Age of John Smith to 29. However, it may do so by first getting the pointer to the database object itself or its first record (e.g., “John Smith”). From there, the executable program may get the address location of the Age record. Then, the executable program may write “29” to replace the previous value.

Thus, the executable program assumes that if a memory location pulled from one record is used to access another record, those two records have a parent-child relationship. The first accessed record is the parent of the second accessed record. Thus, parent and child records are part of the same object.

An executable program (e.g., the direct-IMDB-calling application 152), in accordance with the technology described herein, performs OCT by using a parent-linked, ancestor-tracking (“PLAT”) graph data structure. PLAT is a transient data structure that is scoped to a database transaction performed by the executable program. A PLAT node is an internal structure that is used to maintain the PLAT. It's the node on the PLAT graph. There is one PLAT node for each IMDB object referenced in a current transaction.

When the executable program gets a pointer from the IMDB 224 to a first record location, the associated PLAT node is created to track the object. More particularly, the PLAT node tracks parent and ancestor records, which are presumed to be part of the same object.

Initially, the pointers of the parent and ancestor records are set to each other. That is, the initial pointer to the record location is the value of both the parent and ancestor records in the PLAT node. Subsequently, the executable program may use a pointer derived from a first record location as the pointer to the next or second record location. In response, the executable program assigns the pointer to the second record location as the child or ancestor. Subsequent record locations are recording similarly.

FIGS. 4-6 show flow diagrams of an example methods 400, 500, and 600, which are implementations of the technology described herein. More particularly, the example method 400 focuses on the operations of the direct-IMDB-calling application 152 (or a portion thereof) created by the compiler 150 to perform database transactions directly by applications employing concurrency control an in-memory database and the compilation of expressions to accomplish such database transactions.

Some or all of the operations performed in accordance with the example methods 400, 500, and 600 may be performed by one or more computing systems 102 and/or computing systems 200 operating in a network-based arrangement.

At 402, the computing system obtains a source code in a high-level programming language. For example, the computing system 102 obtains the source code 140.

At 404, the computing system compiles the source code in the high-level programming language into a processor-executable program. For example, the compiler 150 of the computing system 102 compiles the source code 140 into the direct-IMDB-calling application 152.

At 406, the computing system stores the processor-executable program into a memory. For example, the computing system 102 stores the direct-IMDB-calling application 152 (or a portion thereof) in the main memory 120, storage subsystem 112, and/or the main memory 218 of the computing system 200.

At 408, the computing system with an IMDB in its main memory executes the executable program. For example, the computing system 200 has the IMDB 224 thereon its main memory 218. The computing system 200 executes the direct-IMDB-calling application 152 thereon.

The example method 500 focuses on more details of the operation 404 of the direct-IMDB-calling application 152 (or a portion thereof) created by the compiler 150. During the compiling of the direct-IMDB-calling application 152 (or a portion thereof), the operations of the example method 500 are performed.

At 502, the computing system obtains an expression in the source code in the high-level programming language. The expression containing an operand of an IMDB transaction datatype (“transaction-typed operand”). For example, variable “a” in the expression 316 (“b=a+1”) is of the transaction-type as indicated by variable initiation and declaration 312.

At 504, the computing system determines whether the expression includes a transaction-typed operand. If not, the example method 500 ends at operation 506. If so, then the example method 500 continues to operation 508.

At 508, the computing system generates processor-executable instructions. When executed by one or more processors of the computing system, one or more processors can perform a database transaction directly on the IMDB of the primary memory of the computing system. For example, the computing system 200 generates the direct-IMDB-calling application 152 (or a portion thereof), which performs database transactions directly on the IMDB 224 of the main memory 218.

For example, the operation 508 may include the computing system 200 attaining a value from the transaction-typed operand. Using that value as a memory location of a record of the IMDB 224, the computing system 200 may retrieve data from the IMDB record. Then, the computing system 200 may evaluate the expression using the data retrieved from the IMDB record.

In another example, the operation 508 may include the computing system 200 finding a value by evaluating the expression. Using that value as a memory location of a record of the IMDB 224, the computing system 200 may write into the IMDB record.

The database transaction of operation 508 incorporates STM concurrency control techniques for controlling access to the primary memory. Also, the database transaction of operation 508 is performed in a manner that is ACID compliant.

The example method 600 focuses on additional operations of the direct-IMDB-calling application 152 (or a portion thereof) created by the compiler 150 to effectively report that for database purposes, such as for database replication.

At 602, the computing system performs a database transaction on an IMDB on a computer system's primary memory. For example, the computing system 200 performs a database transaction on the IMDB 224. During that database transaction, the computing system performs the operations 604-612.

At 604 and 606, the computing system obtains a first address location of a first database record of the IMDB and stores that first address of the first database record's location as a parent of a database object.

At 608, the computing system obtains a second address location from the first database record. The second address location is a memory location of a second database record of the IMDB.

At 610, the computing system stores the second address location of the second database record as a child of the database object.

At 612, the computing system externalizes the IMDB state based on the parent and child of the database object. That is, the computing system knows the database object based on the tracked parent and child. Thus, the computing system may update that database object when it externalizes the state of the IMDB. For example, the computing system 200 may update the database object of the mirror database system 240.

Externalizing the state of the IMDB of operation 512 may include replicating the database object of the IMDB to a mirror database of the IMDB.

While the invention is described with respect to the specific examples, it is understood that the scope of the invention is not limited to these specific examples. Since other modifications and changes varied to fit particular operating requirements and environments will be apparent to those skilled in the art, the invention is not considered limited to the example chosen for purposes of disclosure. It covers all changes and modifications that do not constitute departures from this invention's true spirit and scope.

Although the application describes embodiments having specific structural features and/or methodological acts, it is to be understood that the claims are not necessarily limited to the specific features or acts described. Rather, the specific features and acts are merely illustrative; some embodiments fall within the scope of the application's claims.

What is claimed is:

1. A computing system comprising:
one or more processors; and
a primary memory with one or more non-transitory computer-readable media having an in-memory database (IMDB) and storing computer-executable instructions that, when executed by the one or more processors, cause the one or more processors to perform operations comprising:
obtaining an expression in a source code in a high-level programming language, the expression containing an operand of an IMDB transaction datatype (“transaction-typed operand”);
determining that the expression contains the transaction-typed operand; and
in-response to the determining, generating processor-executable instructions, that when executed by the one or more processors of the computing system, cause the one or more processors to perform a database transaction directly on the IMDB of the primary memory of the computing system.

2. The computing system of claim 1, wherein the processor-executable instructions, that when executed by one or more processors of a computing system, cause the one or more processors to perform operations comprising:
compiling the source code in the high-level programming language into the processor-executable instructions; and
storing the processor-executable instructions.

3. The computing system of claim 1, wherein the processor-executable instructions, that when executed by one or more processors of a computing system, cause the one or more processors to perform operations comprising:
attaining a value from the transaction-typed operand;
retrieving data from a record of the IMDB on the primary memory of the computer system, the value indicating a location of the record of the IMDB; and
evaluating the expression using the data retrieved from the record in the IMDB.

4. The computing system of claim 1, wherein the processor-executable instructions, that when executed by one or more processors of a computing system, cause the one or more processors to perform operations comprising:
finding a value by evaluating the expression; and
writing into a record of the IMDB on the primary memory of the computer system, the value indicating a location of the record of the IMDB.

5. The computing system of claim 1, wherein the database transaction incorporates software transactional memory (STM) concurrency control for controlling access to the primary memory.

6. The computing system of claim 1, wherein the database transaction performed by the one or more processors of the computing system when executing processor-executable instructions is atomic, consistent, isolated, and durable.

7. The computing system of claim 1, wherein the database transaction on the IMDB includes processor-executable instructions, that when executed by one or more processors of a computing system, cause the one or more processors to perform operations comprising:
obtaining a first address location of a first database record of the IMDB;
storing the first address location of the first database record as a parent of a database object;
obtaining a second address location from the first database record, the second address location being a location of a second database record of the IMDB; and
storing the second address location of the second database record as a child of the database object.

8. A method comprising:
obtaining an expression in source code in a high-level programming language, the expression containing an operand of an in-memory database (IMDB) transaction datatype (“transaction-typed operand”);
determining that the expression contains the transaction-typed operand; and
in-response to the determining, generating processor-executable instructions, that when executed by one or more processors of a computing system, cause the one or more processors to perform a database transaction on an IMDB on a primary memory of the computing system.

9. The method of claim 8 further comprising:
compiling the source code in the high-level programming language into the processor-executable instructions; and
storing the processor-executable instructions.

10. The method of claim 8, wherein the processor-executable instructions, that when executed by one or more processors of a computing system, cause the one or more processors to perform operations comprising:
attaining a value from the transaction-typed operand;
retrieving data from a record of the IMDB on the primary memory of the computer system, the value indicating a location of the record of the IMDB; and
evaluating the expression using the data retrieved from the record in the IMDB.

11. The method of claim 8, wherein the processor-executable instructions, that when executed by one or more processors of a computing system, cause the one or more processors to perform operations comprising:
finding a value by evaluating the expression; and
writing into a record of the IMDB on the primary memory of the computer system, the value indicating a location of the record of the IMDB.

12. The method of claim 8, wherein the database transaction incorporates software transactional memory (STM) concurrency control for controlling access to the primary memory.

13. The method of claim 8, wherein the database transaction performed by the one or more processors of the computing system when executing processor-executable instructions is atomic, consistent, isolated, and durable.

14. One or more non-transitory computer-readable media storing processor-executable program of claim 8.

15. The method of claim 8, wherein the database transaction on the IMDB includes processor-executable instructions, that when executed by the one or more processors of a computing system, cause the one or more processors to perform operations comprising:
obtaining a first address location of a first database record of the IMDB;
storing the first address location of the first database record as a parent of a database object;
obtaining a second address location from the first database record, the second address location being a location of a second database record of the IMDB; and
storing the second address location of the second database record as a child of the database object.

16. One or more non-transitory computer-readable media storing computer-executable instructions that, when executed by one or more processors, cause the one or more processors to perform operations comprising:
transacting on an in-memory database (IMDB) on a primary memory of a computer system;
during the transacting:
obtaining a first address location of a first database record of the IMDB;
storing the first address location of the first database record as a parent of a database object;
obtaining a second address location from the first database record, the second address location being a location of a second database record of the IMDB;
storing the second address location of the second database record as a child of the database object; and
externalizing state of the IMDB based on the parent and child of the database object.

17. The one or more non-transitory computer-readable media of claim 16, wherein the externalizing the state of the IMDB includes replicating the database object of the IMDB to a mirror database of the IMDB.

18. The one or more non-transitory computer-readable media of claim 16, wherein the operations further comprising:
obtaining an expression in source code in a high-level programming language, the expression containing an operand of an IMDB transaction datatype (“transaction-typed operand”);
determining that the expression contains the transaction-typed operand; and
in-response to the determining, generating processor-executable instructions, that when executed by one or more processors of the computing system, cause the one or more processors to perform a database transaction on the IMDB of the primary memory of the computing system.

19. The one or more non-transitory computer-readable media of claim 18, wherein the operations further comprising:
compiling the source code in the high-level programming language into the processor-executable instructions; and
storing the processor-executable instructions.

20. The one or more non-transitory computer-readable media of claim 16, wherein the transacting on the IMDB incorporates software transactional memory (STM) concurrency control for controlling access to the primary memory.
